(19) United States
(12) Patent Application Publication
(10) Pub. No.: US 2024/0245052 A1
(43) Pub. Date: Jul. 25, 2024

(54) A COMPOSITE SYSTEM FOR AGRICULTURE

(71) Applicant: UPL LIMITED, Mumbai (IN)

(72) Inventors: Rajan Ramakant SHIRSAT, Mumbai (IN); Shiv Kumar SHARMA, Mumbai (IN); Pradip Dattatray WAGH, Mumbai (IN)

(21) Appl. No.: 18/293,033

(22) PCT Filed: Jul. 29, 2022
(86) PCT No.: PCT/IB2022/057053

§ 371 Date: Jan. 29, 2024

(30) Foreign Application Priority Data
Jul. 30, 2021 (IN) 202121034512

(51) Int. Cl. A01N 37/02; A01G 7/06; A01N 25/04; A01N 37/22; A01N 43/36; A01N 43/56; A01N 43/78; A01N 43/80; A01N 51/00; A01N 53/00

(52) U.S. Cl. CPC A01N 37/02; A01G 7/06; A01N 25/04; A01N 37/22; A01N 43/36; A01N 43/56; A01N 43/78; A01N 43/80; A01N 51/00; A01N 53/00

(57) ABSTRACT

The present invention discloses a composition comprising superabsorbent polymers in the form of flowable suspension that aid in seed treatment as well as soil quality improvement. The present invention further discloses process of preparing the composition for agriculture and a method of improving seed and soil health using the composite system.

### FIELD OF THE INVENTION

The present invention relates to a composite system for agriculture. The present invention more particularly relates to the composite system for agriculture comprising a superabsorbent polymer in the form of flowable suspension that aid in seed treatment as well as soil quality improvement. The present invention further relates to a process of preparing the composite system for agriculture and a method of improving seed and soil health using said composite system.

### BACKGROUND OF THE INVENTION

Superabsorbent polymer (SAP) is a material that can absorb significant amounts of water relative to its mass. The nature and properties of SAP make it a widely utilized material across many disciplines. SAP is vastly used in agricultural or horticultural applications. Applying SAP to soil in agricultural settings has resulted in early seed germination and/or blooming, decreased irrigation requirements, increased propagation, increased crop growth and production, increased crop quality, decreased soil crusting, increased yield, and decreased time of emergence.

There are various known methods for applying SAP in agricultural applications. Conventionally, SAP is applied to soil in granular form, typically before or while planting crops. Applying granular SAP to existing crops or vegetation becomes difficult as SAP's are most effective when they are applied to the root zone. Typically, there are several methods of applying SAP to the existing vegetation such as by digging a hole in soil and blowing SAP under pressure around the root zone; by removing a small portion of soil surrounding roots and replacing it with SAP; or by temporarily uprooting the vegetation and applying SAP and placing them back. However, these conventional methods have proved to be inefficient, expensive, and disruptive to the root system of existing vegetation.

Moreover, adding SAP to water is very different from adding SAP to most other materials. However, when SAP is added to water, turbulence is required for sufficient mixing. Without sufficient mixing, SAP will not dissolve immediately and will form agglomerates. These agglomerates may then enter the field and float down the furrow. Not all are so, but the agglomerates cannot be used with the injector system.

Another agricultural application of SAP is in the seed coating or seed blending. Generally, superfine SAP with 80 to 300 mesh size can be applied, especially a 100-200 mesh size SAP is used. While coating/blending seeds with superfine SAP, the user faces a dustiness challenge which is unacceptable, as it is likely to cause serious health hazards by choking the intranasal passage of the user. Similarly, when these superfine SAP's are applied onto seeds for soil application in its original dried form, severe dust-off and rub-off problems occur which are undesirable to the seed treatment process and causes inferior results in seed health and quality.

The application of SAP in a flowable state is a better technique but comes with its own challenges that makes its application even more difficult. As soon as SAP is brought in contact with water, it swells and forms a hydrogel that is too gelatinous and difficult to be absorbed through soil. To overcome this problem, if SAP is further diluted with a significant amount of water, there remains no scope of enough SAP per unit volume to have a significant enough water-absorbing effect upon application, or alternatively it would require the application of a large volume of water to deliver an effective amount of the SAP product. The above problem is further aggravated when superfine particles of SAP ranging from 80 mesh to 200 mesh size are to be applied in a flowable state.

Several attempts have been made in the past to formulate SAP in the liquid form or dilute SAP with water before its agricultural applications.

PCT Publication No. WO2009014824A2 discloses mixing of starch graft copolymer superabsorbent product with a liquid fertilizer to form a flowable and pumpable suspension having viscosity ranging from 1 to 55,000 centipoise. Mixing of SAP particles with a liquid fertilizer comprises a N-P-K-S macronutrient fertilizer chosen from: 32-0-0-0, 28-0-0-0, 10-34-0-0, 12-0-0-26, 20-0-0-0, 3-18-18-0, 20-0-0-5, 0-0-15-0, and 0-0-13-0 has a limited purpose of sufficing plant nutrient need but it cannot be applied as a universal solution because manufacturing SAP's in the flowable state might have other reasons too such as 1) handling dust-off during manufacture and application; 2) facilitating the application of active ingredients required for crops/plants treatment; 3) acting as an aid during tank mixing of SAP with other mixture partners.

Japanese Patent Publication No. JP2788522B2 discloses an insecticide-releasing flowable composition capable of changing the viscosity for controlling insects in an aquatic environment under pre-flooding or flooding conditions, comprising: (a) self-weighting in water, at least one superabsorbent solid organic polymer consisting of a hydrophilic acrylamide or an acrylate polymer (copolymer or terpolymer) that absorbs more than 100 times the water; (b) an effective amount of at least one different pesticide; and (c) water or oil, wherein the composition is obtained by mixing under vigorous high shear. JP'522 further recommends that in the absence of high shear, addition of electrolytes/salts is required to obtain a flowable composition. A drawback of this prior art is that conventionally, it has proved difficult to apply SAPs in a flowable state, since introducing SAPs to water will cause water to be entrapped within the SAP matrix, swell in size, and form a hydrogel that is too gelatinous and difficult to be absorbed through sod or soil. Furthermore, for a water-diluted SAP product to be flowable enough to be used in spray applications it must be diluted with a significant amount of water, such that there is not enough SAP per unit volume to have a significant enough water-absorbing effect upon application, or alternatively it would require the application of a large volume of water to deliver an effective amount of the SAP product.

Although, developing formulations consisting of SAP in a flowable state have been attempted in the past, there is still a need that exists for developing SAP, especially superfine SAP in a flowable state which overcomes drawbacks and shortcomings of the prior art and provides an easy to formulate and an easy-to-use SAP composition meant for various agricultural applications.

### OBJECTIVES OF THE INVENTION

An objective of the present invention is to provide a composite system/composition for agriculture.

Another objective of the present invention is to provide a composite system/composition for agriculture comprising superabsorbent polymer.

An objective of the present invention is to provide a composite system/composition for agriculture comprising superabsorbent polymer in the form of flowable suspension.

An objective of the present invention is to provide a composite system/composition for agriculture that can combine with other seed treating agents.

An objective of the present invention is to provide a composite system/composition for agriculture that aid plants in handling environmental stress.

An objective of the present invention is to provide a composite system/composition for agriculture that prevents dust-off problem.

Still another objective of the present invention is to provide a process for the preparation of a composite system/composition for agriculture comprising starch-based SAPs.

Yet another objective of the present invention is to provide method of treatment of plants and seeds for agriculture.

### SUMMARY OF THE INVENTION

In an aspect of the present invention, there is provided a composite system for agriculture comprising:
a superabsorbent polymer, and
a solvent system comprising water and a glycolic solvent;
wherein the composite system is in the form of a flowable suspension.

In an aspect of the present invention, there is provided a composite system for agriculture comprising:
a superabsorbent polymer, and
a solvent system comprising water and a glycolic solvent in a ratio ranging from 1:5 to 5:1;
wherein the composite system is in the form of a flowable suspension.

In another aspect of the present invention, there is provided a composite system for agriculture comprising:
a superabsorbent polymer; and
a solvent system comprising water and a glycolic solvent in a ratio ranging from 1:3 to 3:1,

wherein the composite system is in the form of a flowable suspension.

In another aspect of the present invention, there is provided a composition comprising:
a superabsorbent polymer; and
a solvent system comprising water and a glycolic solvent in a ratio ranging from 1:3 to 3:1,

wherein the composition is in the form of a flowable suspension.

In another aspect of the present invention, there is provided a composite system for agriculture comprising:
a superabsorbent polymer;
at least one dispersant; and
a solvent system comprising water and a glycolic solvent in a ratio ranging from 1:3 to 3:1,

wherein the composite system is in the form of a flowable suspension.

In another aspect of the present invention, there is provided a composition comprising;
a superabsorbent polymer;
at least one dispersant; and
a solvent system comprising water and a glycolic solvent in a ratio ranging from 1:3 to 3:1,

wherein the composition is in the form of a flowable suspension.

In another aspect of the present invention, there is provided a composite system for agriculture comprising:
a superabsorbent polymer,
   at least one agrochemical ingredient, and
a solvent system comprising water and a glycolic solvent in a ratio ranging from 1:3 to 3:1,

wherein the composite system is in the form of a flowable suspension.

In another aspect of the present invention, there is provided a composition comprising:
a superabsorbent polymer,
   at least one agrochemical ingredient,
at least one dispersant;
a solvent system comprising water and a glycolic solvent in a ratio ranging from 1:3 to 3:1,

wherein the composition is in the form of a flowable suspension.

In yet another aspect of the present invention, there is provided a process of preparing a composite system for agriculture comprising a superabsorbent polymer, and a solvent system comprising water and a glycolic solvent in a ratio ranging from 1:3 to 3:1; wherein said process comprising steps of:
mixing at least one glycolic solvent with water to obtain a solvent system,
adding the superabsorbent polymer under high shear to obtain the composite system as a flowable suspension.

In yet another aspect of the present invention, there is provided a process of preparing a composition comprising a superabsorbent polymer, and a solvent system comprising water and a glycolic solvent in a ratio ranging from 1:3 to 3:1; wherein said process comprising steps of:
mixing at least one glycolic solvent with water to obtain a solvent system,
adding the superabsorbent polymer under high shear to obtain the composition as a flowable suspension.

In another aspect of the present invention, there is provided a method of enhancing propagation in plants, said method comprising applying to propagation material of agriculture crops, an effective amount of the composite system comprising a superabsorbent polymer, and a solvent system comprising water and a glycolic solvent in a ratio ranging from 1:3 to 3:1; wherein said composite system is in the form of a flowable suspension.

In another aspect of the present invention, there is provided a method of enhancing seedling development, said method comprising: applying to seeds of agriculture crops, an effective amount of a composite system comprising a superabsorbent polymer, and a solvent system comprising water and glycolic solvent in a ratio ranging from 1:3 to 3:1; wherein said composite system is in the form of a flowable suspension.

In yet another aspect of the present invention, there is provided a method of enhancing seedling development comprising applying to seeds of agriculture crops, an effective amount of a composite system comprising a superabsorbent polymer, at least one active ingredient and a solvent system comprising water and glycolic solvent in a ratio ranging from 1:3 to 3:1; wherein said composite system is in the form of a flowable suspension.

In another aspect of the present invention, there is provided a method of improving soil quality comprising applying to soil, an effective amount of a composite system for agriculture comprising superabsorbent polymer, and a solvent system comprising water and glycolic solvent in a ratio ranging from 1:3 to 3:1 wherein said composite system is in the form of a flowable suspension.

In another aspect of the present invention, there is provided a method of enhancing propagation in plants, said method comprising applying to propagation material of agriculture crops, an effective amount of the composition comprising a superabsorbent polymer, and a solvent system comprising water and a glycolic solvent in a ratio ranging from 1:3 to 3:1; wherein said composition is in the form of a flowable suspension.

In another aspect of the present invention, there is provided a method of enhancing seedling development, said method comprising: applying to seeds of agriculture crops, an effective amount of a composition comprising a superabsorbent polymer, and a solvent system comprising water and glycolic solvent in a ratio ranging from 1:3 to 3:1; wherein said composition is in the form of a flowable suspension.

In another aspect of the present invention, there is provided a method of improving soil quality comprising applying to soil, an effective amount of a composition for agriculture comprising superabsorbent polymer, and a solvent system comprising water and glycolic solvent in a ratio ranging from 1:3 to 3:1 wherein said composition is in the form of a flowable suspension.

In another aspect of the present invention, the composite system for agriculture is used as a vehicle to aid agrochemical treatment of seeds and soil.

### DETAILED DESCRIPTION OF DRAWINGS

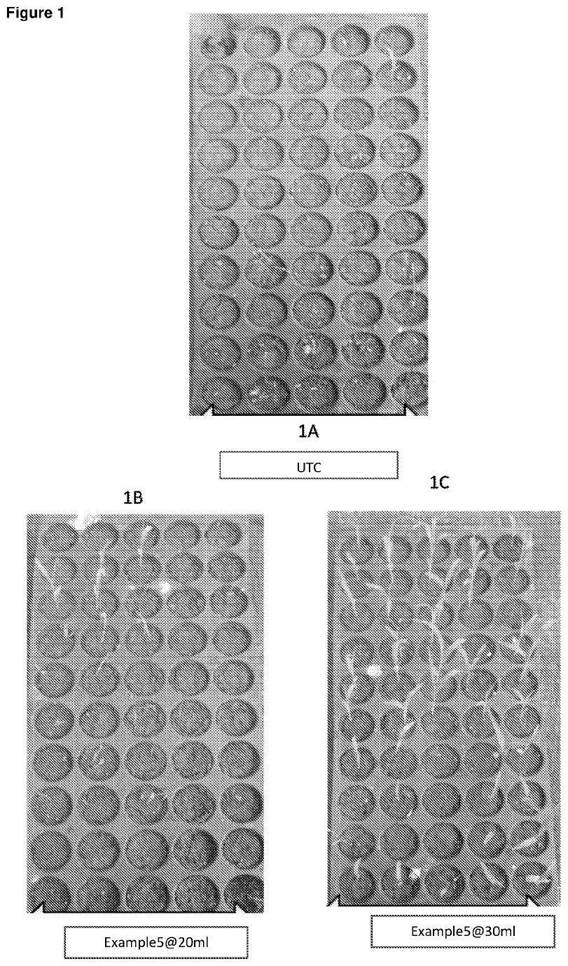

FIG. 1 depicts the seed germination test in sorghum seeds. FIG. 1 (a) depicts the seed germination in the untreated control; FIGS. 1(b) and 1(c) depicts the seed germination in seeds treated with the composition prepared as in Example 5 at 20 ml and 30 ml, respectively.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein. The present invention will now be described in detail on the basis of exemplary embodiments.

The terms used in the following description and claims are not limited to the bibliographical meanings but are merely used by the inventor to enable a clear and consistent understanding of the invention. Accordingly, it should be apparent to those skilled in the art that the following description of exemplary embodiments of the present disclosure are provided for illustration purpose only and not for limiting the scope of the invention as defined by the appended claims and their equivalents.

For the purposes of the present disclosure, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present disclosure in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term.

Prior to setting forth the present subject matter in detail, it may be helpful to provide definitions of certain terms used herein. Unless defined otherwise, all technical and scientific terms used herein have the same meaning as is commonly understood by one of skill in the art to which this subject matter pertains. The following definitions are provided for clarity.

Unless defined otherwise, all technical and scientific terms used herein have the same meaning as commonly understood by one of ordinary skill in the art to which this invention belongs. It must be noted that, as used in this specification, the singular forms “a,” “an” and “the” include plural referents unless the content clearly dictates otherwise.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

The aspects and embodiments described herein shall also be interpreted to replace the clause “comprising” with either “consisting of” or with “consisting essentially of” or with “consisting substantially of”.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

As used herein the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” as used herein denotes the vicinity or area designated for growth of a desired crop, and in which control of the growth and/or spread of undesirable vegetation is desired. The locus includes the vicinity of desired crop plants wherein undesirable vegetation growth has either occurred, is most likely to occur, or is yet to occur.

The salts referred to herein are agriculturally acceptable salts. As used herein, an “agriculturally acceptable salt” means a salt which is acceptable for use in agricultural or horticultural use.

Within the context of this specification, the terms “superabsorbent polymer” or “SAP” or “polymer gel” refers to water swellable polymers that can absorb water many times their weight in an aqueous solution. Without wishing to be bound by theory, the term superabsorbent polymers also apply to polymers that absorb water as well as de-sorb the absorbed water. The superabsorbent polymer may be selected from but not limited to water-swellable or water absorbing or water-retentive polymers such as cross-linked polymers that swell without dissolving in the presence of water, and may, absorb at least 10, 100, 1000, or more times their weight in water.

SAPs may be used in agricultural or horticultural applications. The terms “agricultural” and “horticultural” are used synonymously and interchangeably throughout the present disclosure. Applying SAPs to soil in agricultural settings have resulted in earlier seed germination and/or blooming, decreased irrigation requirements, increased propagation, increased crop growth and production, increased crop quality, decreased soil crusting, increased yield and decreased time of emergence.

The viscosity of the formulations of Example 12 and 13 was measured as per CIPAC MT 22.1. The measurement of dynamic viscosity is carried at room temperature. Sample to be tested for viscosity was kept undisturbed for 1 hour before measurement

Within the context of this specification, the term “composite system” refers to a composition comprising a superabsorbent polymer and a solvent system comprising water and a glycolic solvent which can used in various agricultural applications, both in soil as well as on seeds.

Within the context of this specification, the term “flowable suspension” refers to a composite system for agriculture having viscosity ranging from 500 to 2500 cps that allows the flowable suspension to be directly applied onto propagation material or onto seeds for seed treatment; and efficiently mixed with other formulations or diluted with water before application without involving greater external force facilitating mixing.

Within the context of this specification, the term “superfine SAPs” refer to SAP particles having size 80 to 300 mesh, especially 100 to 200 mesh.

Surprisingly, the inventors of the present invention found that the superabsorbent polymer can be formulated in a flowable state as a composite system for agricultural use by mixing it with a solvent system comprising water and a glycolic solvent. Such a solvent system assists the SAP to stay in a liquid state without being swollen. The composite system as a flowable suspension of the SAP in a solvent system comprising water and a glycolic solvent found to be suitable for a variety of agricultural applications such as in-furrow application, root dipping, seed dressing and seed treatment alone or in combination with other active ingredients. Also, the composite system for agriculture was found to be suitable for tank-mix applications by acting as a medium for incorporating tank-mix partners such as active ingredients, colorants, dyes, extenders, adjuvants etc.

Further, the SAP used in a composite system for agriculture is a starch graft copolymer, the composite system for agriculture becomes environment friendly. The starch graft copolymer comprises a monomer graft polymerized onto a polysaccharide, such as starch or cellulose. The starch graft copolymer is biodegradable and is typically used to absorb aqueous fluids, to increase the water holding capacity of soil, and as coatings onto seeds, fibers, clays, and the like. Due to its biodegradable nature, starch-based SAPs are a preferred choice of growers.

Accordingly, an embodiment of the present invention provides a composite system for agriculture comprising:
a superabsorbent polymer, and
a solvent system comprising water and a glycolic solvent;

wherein the composite system is in the form of a flowable suspension.

In another embodiment the present invention provides a composition comprising:
a superabsorbent polymer, and
a solvent system comprising water and a glycolic solvent;

wherein the composition is in the form of a flowable suspension.

According to an embodiment, the superabsorbent polymer of the composite system or of the composition is selected from, but not limited to, copolymer of acrylamide and sodium acrylate, copolymer of acrylamide and potassium acrylate; hydrolyzed starch-polyacrylonitrile; 2-propenenitrile homopolymer), or poly(2-propenamide-co-2-propanoic acid, sodium salt); starch-g-poly(2propenamide-co-2-propanoic acid, mixed sodium and aluminium salts); starch-g-poly(2-propenamide-co-2-propanoic acid, potassium salt); poly(2-propenamide-co-2-propanoic acid, sodium salt); Starch-g-poly (propenoic acid) sodium salt, Starch-g-poly (propenoic acid) potassium salt, poly-2-propanoic acid, sodium salt; starch-g-poly(acrylonitrile) or poly(2-propenamide-co-sodium acrylate); starch/acrylonitrile copolymer; crosslinked copolymers of acrylamide and sodium acrylate; crosslinked polymers of acrylamide and sodium polyacrylate; anionic polyacrylamide; starch grafted sodium polyacrylates; crosslinked copolymers of potassium polyacrylate and polyacrylamide; sodium polyacrylate; superabsorbent polymer laminates and composites; partial sodium salt of crosslinked polypropenoic acid; potassium polyacrylate, lightly crosslinked; sodium polyacrylate, lightly crosslinked; poly(sodiumacrylate) homopolymer; polyacrylamide polymers, carrageenan, agar, alginic acid, guar gums and its derivatives, and gellan gum.

According to a preferred embodiment of the present invention, the superabsorbent polymer is selected from a starch-based superabsorbent polymer that includes a monomer graft polymerized onto starch in the presence of an initiator to form a starch graft copolymer.

According to a preferred embodiment of the present invention, the superabsorbent polymer is selected from the group comprising of copolymers of hydrolyzed starch-polyacrylonitrile; 2-propenenitrile homopolymer, hydrolyzed, sodium salt or poly(acrylamide co-sodium acrylate) or poly(2-propenamide-co-2-propanoic acid, sodium salt); starch-g-poly(2propenamide-co-2-propanoic acid, mixed sodium and aluminium salts); starch-g-poly(2-propenamide-co-2-propanoic acid, potassium salt); poly(2-propenamide-co-2-propanoic acid, sodium salt); poly-2-propanoic acid, sodium salt; starch-g-poly(acrylonitrile) or poly(2-propenamide-co-sodium acrylate).

In a preferred embodiment, the superabsorbent polymer is selected from the group comprising of starch-g-poly (2-propenamide-co-2-propenoic acid) potassium salt, starch-g-poly (2-propenamide-co-2-propenoic acid) sodium salt, starch-g-poly (propenoic acid) sodium salt, starch-g-poly (propenoic acid) potassium salt, sodium polyacrylamide and potassium polyacrylamide.

According to a preferred embodiment of the present invention, the superabsorbent polymer is a starch-g-poly (2-propenamide-co-2-propenoic acid) potassium salt or its crosslinked polyacrylic acid potassium salt.

According to another embodiment of the present invention, particle size of the superabsorbent polymer is in the range from about 80 mesh to about 300 mesh.

For example, in some applications where the starch graft copolymer is applied directly into the soil with the crop, the particle size is coarser than about 80 mesh.

According to another embodiment of the present invention, depending on the agricultural application, the final SAP product may have a particle size that is coarser than about 300 mesh.

According to another embodiment of the present invention, finer particle sizes of the SAP may be used in seed coating or root dipping applications. By way of example, the particle size for seed coating may be between 100 to about 300 mesh, such as about 100 mesh. For root coating, the particle size may be between about 80 mesh and about 100 mesh, such as about 100 mesh. Depending on the application, the SAP particles may be in powder form, however granular, flake, pelletized or rod-shaped SAP products may also be used. Any size or form of the SAP particle may be used suitable for each application as would be apparent to those having skill in the art with the aid of the present disclosure.

According to another embodiment of the present invention, the composition comprises from about 0.1% w/w to about 99.9% w/w and preferably from about 50% w/w to about 99.5% w/w of the superabsorbent polymer of the total weight of the composition.

According to an embodiment of the present invention, the superabsorbent polymer has a moisture content ranging from 5% to 15%.

According to an embodiment of the present invention, the superabsorbent polymer has a water absorption capacity from about 300 times to about 1000 times its weight.

According to an embodiment of the present invention, the superabsorbent polymer has a water absorption capacity from about 500 times to about 800 times its weight.

According to an embodiment of the present invention, the superabsorbent polymer is in the form of powder and granules.

According to a preferred embodiment of the present invention, superabsorbent polymer is in the form of a powder.

According to a preferred embodiment of the present invention, superabsorbent polymer is in the form of granules.

According to an embodiment of the present invention, superabsorbent polymer is biodegradable.

According to another embodiment of the present invention, the composite system comprises a solvent system comprising water and a glycolic solvent.

According to another embodiment of the present invention, the composition comprises a solvent system comprising water and a glycolic solvent.

According to another embodiment of the present invention, the glycolic solvent of the composite system for agriculture is selected from the group comprising of diethylene glycol, propylene glycol, ethylene glycol monobutyl ether (EGBE), and ethylene glycol monomethyl ether (EGME).

According to another embodiment of the present invention, solvent system comprises from about 1% w/w to about 50% w/w water of the total weight of the solvent system.

According to another embodiment of the present invention, solvent system comprises from about 10% w/w to about 40% w/w water of the total weight of the solvent system.

According to another embodiment of the present invention, solvent system comprises from about 10% w/w to about 80% w/w glycolic solvent of the total weight of the solvent system.

According to another embodiment of the present invention, solvent system comprises from about 20% w/w to about 70% w/w glycolic solvent of the total weight of the solvent system.

According to another embodiment of the present invention, composite system or composition comprises from about 0.1% w/w to about 99.9% w/w solvent system of the total weight of the composition.

According to another embodiment of the present invention, composite system or composition comprises from about 1% w/w to about 90% w/w solvent system of the total weight of the composition.

In a preferred embodiment of the present invention, the composite system or composition comprises from about 10% w/w to about 90% w/w solvent system of total weight of the composition.

According to another embodiment of the present invention, the composite system or composition comprises from about 0.1% w/w to about 99.9% w/w solvent system of the total weight of the composition.

According to another embodiment of the present invention, the composite system or composition comprises from about 1% w/w to about 90% w/w solvent system of the total weight of the composition.

In a preferred embodiment of the present invention, the composition comprises from about 10% w/w to about 90% w/w solvent system of total weight of the composition.

According to another embodiment of the present invention, there is provided a composite system for agriculture comprising:
superabsorbent polymer; and
a solvent system comprising water and a glycolic solvent in a ratio from 1:5 to 5:1,

wherein the composite system is in the form of a flowable suspension.

According to another embodiment of the present invention, there is provided a composition for agriculture comprising:
superabsorbent polymer; and
a solvent system comprising water and a glycolic solvent in a ratio from 1:5 to 5:1,

wherein the composition is in the form of a flowable suspension.

According to an embodiment of the present invention, solvent system comprises water and glycolic solvent in a ratio from 1:5.

According to an embodiment of the present invention, solvent system comprises water and glycolic solvent in a ratio from 1:4.

According to an embodiment of the present invention, solvent system comprises water and glycolic solvent in a ratio from 1:3.5.

According to another embodiment of the present invention, there is provided a composite system for agriculture comprising:
superabsorbent polymer; and
a solvent system comprising water and a glycolic solvent in a ratio from 1:3 to 3:1,

wherein the composite system is in the form of a flowable suspension.

According to another embodiment of the present invention, there is provided a composition for agriculture comprising:
superabsorbent polymer; and
a solvent system comprising water and a glycolic solvent in a ratio from 1:3 to 3:1,

wherein the composition is in the form of a flowable suspension.

According to an embodiment of the present invention, solvent system comprises water and glycolic solvent in a ratio from 1:3 to 3:1.

According to an embodiment of the present invention, solvent system comprises water and glycolic solvent in a ratio 1:3.

According to an embodiment of the present invention, solvent system comprises water and glycolic solvent in a ratio 3:1.

According to an embodiment of the present invention, solvent system comprising water and glycolic solvent in a ratio 1:1.5.

According to an embodiment of the present invention, solvent system comprising water and glycolic solvent in a ratio 1:1.

According to an embodiment of the present invention the composite system is in the form of a flowable suspension.

According to an embodiment of the present invention, the composite system for an agricultural composition is in the form of a flowable suspension having viscosity ranging from 100 to 2500 cps.

According to an embodiment of the present invention, the composite system for an agricultural composition is in the form of a flowable suspension having viscosity ranging from 800 to 2100 cps.

According to an embodiment of the present invention, the composite system for an agricultural composition is in the form of a flowable suspension having viscosity ranging from 1000 to 2000 cps.

According to an embodiment of the present invention, the composition is in the form of a flowable suspension having viscosity ranging from 100 to 2500 cps.

According to an embodiment of the present invention, the composite system or a composition comprises from about 0.01% w/w to about 30% w/w superabsorbent polymer and from about 10% w/w to about 99.9% w/w solvent system of the total weight of the composite system for agriculture.

According to an embodiment of the present invention, the composite system or a composition comprises from about 0.1% w/w to about 20% w/w superabsorbent polymer and from about 10% w/w to about 90% w/w solvent system of the total weight of the composite system for agriculture.

According to an embodiment of the present invention, the composite system or a composition comprises from about 0.5% w/w to about 10% w/w superabsorbent polymer and from about 10% w/w to about 85% w/w solvent system of the total weight of the composite system for agriculture.

According to an embodiment of the present invention, the composite system or a composition comprises from about 0.5% w/w to about 10% w/w starch based superabsorbent polymer and from about 10% w/w to about 85% w/w solvent system of the total weight of the composite system for agriculture.

According to another embodiment of the present invention, there is provided a composite system for agriculture comprising:
superabsorbent polymer;
at least one dispersant; and
a solvent system comprising water and a glycolic solvent in a ratio from 1:3 to 3:1,

wherein the composite system is in the form of a flowable suspension

According to an embodiment, the composite system for agriculture comprises of dispersants.

According to another embodiment of the present invention, there is provided a composition for agriculture comprising:
superabsorbent polymer;
at least one dispersant; and
a solvent system comprising water and a glycolic solvent in a ratio from 1:3 to 3:1,

wherein the composition is in the form of a flowable suspension

According to an embodiment, the composite system for agriculture comprises of dispersants selected from the group comprising of non-ionic and anionic surfactants.

According to an embodiment, the composite system or a composition comprises of non-ionic surfactants selected from the group comprising of fatty alcohol ethoxylates, tristyrylphenol ethoxylates, alkylphenolethoxylates, castor oil ethoxylates, fatty acid ethoxylates, alkylpolyglucosides, sorbitan ethoxylates, and ethylene oxide-propylene oxide-ethylene oxide block copolymers, alkoxylated alcohols (e.g., SYNPERONIC All), polyoxyethylene/polyoxypropylene block polymers (e.g., PLURONIC F108, ATLOX 4912, ATLAS G-5000, SYNPERONIC PE series copolymers), ethylene oxide-propylene oxide based polycarboxylic acid graft copolymers such as hydrophilic methyl methacrylate graft copolymers (e.g., ATLOX 4913) and poly-12-hydroxystearic acid graft copolymers, for example, with polyethylene glycol (e.g., ATLOX 4912), and polyethylene glycol alkyd resins (e.g., ATLOX 4914).

According to an embodiment, the composite system or a composition comprises of anionic surfactants selected from the group comprising salts of dodecylbenzenesulfonate, sodium dioctylsulfosuccinate, alkyl aryl sulphonates, lignin sulphonates, salts of tristyrylphenol ethoxylate phosphates, salts of fatty acids, salts of alkyl sulfates, salts of alkylether sulfates, salts of alkylether phosphates, and sodium N-methyl-N-oleyltaurate.

According to an embodiment, the composite system or a composition comprises from about 1% w/w to about 25% w/w, preferably 5% w/w to about 20% w/w dispersants of the total weight of the composite system.

According to an embodiment of the present invention, the composite system or a composition comprises from about 0.01% w/w to about 30% w/w superabsorbent polymer, from about 10% w/w to about 99.9% w/w solvent system and from 0.1% w/w to about 20% w/w dispersants of the total weight of the composite system for agriculture.

According to an embodiment of the present invention, the composite system comprises from about 0.01% w/w to about 30% w/w superabsorbent polymer, from about 10% w/w to about 99.9% w/w solvent system wherein said solvent system comprises from about 1% w/w to about 50% w/w water and from about 10% w/w to about 80% w/w glycol in a 1:3 ratio and from 0.1% w/w to about 20% w/w dispersants of the total weight of the composite system for agriculture.

According to an embodiment of the present invention, the composition comprises from about 0.01% w/w to about 30% w/w superabsorbent polymer, from about 10% w/w to about 99.9% w/w solvent system wherein said solvent system comprises from about 1% w/w to about 50% w/w water and from about 10% w/w to about 80% w/w glycol in a 1:3 ratio and from 0.1% w/w to about 20% w/w dispersants of the total weight of the composite system for agriculture.

According to an embodiment of the present invention, the composite system or a composition comprises from about 0.01% w/w to about 30% w/w superabsorbent polymer, from about 10% w/w to about 99.9% w/w solvent system wherein said solvent system comprises from about 1% w/w to about 50% w/w water and from about 10% w/w to about 80% w/w glycol in a 3:1 ratio and from 0.1% w/w to about 20% w/w dispersants of the total weight of the composite system for agriculture.

According to an embodiment of the present invention, the composite system or a composition comprises of at least one agrochemically acceptable excipient.

According to an embodiment of the present invention, the composition comprises of at least one agrochemically acceptable excipient.

According to an embodiment of the present invention, the composite system for agriculture may include one or more adjuvants selected from surfactants (emulsifier), crop oil, fertilizers, dispersing agents, biocide, compatibility agents, foaming activators, foam suppressants, correctives, and spray colorants (dyes).

Preservatives used may be benzisothiazolinone (Proxel GXL) or phenols, 2-bromo-2-nitropropane-1,3-diol (Bioban BP 30), 5-chloro-2-methyl-4-isothiazolin-3-one & 2 methyl-4-isothiazolin-3 one (Kathon CG/ICP), Glutaraldehyde (Ucarcide 50), Chloromethylisothiazolinone (CMIT)/Methylisothiazolinone (MIT) (Isocil Ultra 1.5), 2.2-dibromo-3-nitrilopropioamide (Reputain 20), Natamycin & Nisin, Bronopol/CMIT/MIT (Mergal 721 K3). Our preferred biocide is Proxel GXL.

According to an embodiment of the present invention, the composite system for agriculture comprises from about 0.1% to about 30% and preferably from about 0.5% to about 25% adjuvant of the total weight of the composite system for agriculture.

According to another embodiment of the present invention, there is provided a composite system for agriculture comprising:
a superabsorbent polymer,
at least one agrochemical ingredient, and
a solvent system comprising water and glycolic solvent in a ratio from 1:3 to 3:1,

wherein the composite system is in the form of a flowable suspension

According to another embodiment of the present invention, there is provided a composition comprising:
a superabsorbent polymer,
at least one agrochemical ingredient, and
a solvent system comprising water and glycolic solvent in a ratio from 1:3 to 3:1,

wherein the composition is in the form of a flowable suspension

According to another embodiment of the present invention, there is provided a composition comprising:
a superabsorbent polymer,
a dispersant,
at least one agrochemical ingredient, and
a solvent system comprising water and glycolic solvent in a ratio from 1:3 to 3:1,

wherein the composition is in the form of a flowable suspension

According to an embodiment of the present invention, the composite system for agriculture or composition comprises of at least one agrochemical ingredient.

According to an embodiment of the present invention, the composite system for agriculture or composition comprises of at least one agrochemical ingredient selected from the group comprising of herbicides, fungicides, insecticides, plant growth regulators, biologicals, botanical extracts, macronutrients, micronutrients and the like.

According to an embodiment of the present invention, the composite system for agriculture or composition comprises of herbicides selected from the group comprising of amide, anilide, chloroacetanilide, cyclohexene oxime, dinitroaniline, diphenyl ether, imidazolinone, organophosphorous, aryloxyphenoxy propionic, pyridine, triazine, triazinone, triazolone, triazole, phenylurea groups and the like.

According to an embodiment of the present invention, the composite system for agriculture comprises of fungicides selected from the group comprising of amide, anilide, benzamide, sulfonamide, strobilurins, benzimidazole, pyrazole carboxamide, carbamate, conazole, dinitrophenol, dithiocarbamate, imidazole, organophosphorous, pyridine, pyrimidine, pyrrole, quinoline, thiazole groups and the like.

According to an embodiment of the present invention, the composite system for agriculture comprises of insecticides selected from the group comprising of carbamate, diamide, dinitrophenol, isooxazoline, spinosyn, organophosphorous, pyrethroid group and the like.

According to another embodiment of the present invention, there is provided an agricultural composition comprising:
superabsorbent polymer,
a pyrethroid, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant
a pyrethroid, and
a solvent system comprising water and glycolic solvent in a ratio from 1:3 to 3:1,

wherein the composition is in the form of a flowable suspension.

In an embodiment, the pyrethroid is selected from the group comprising acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, (1R)-trans-isomers], deltamethrin, empenthrin (EZ)-(1R)-isomers], esfenvalerate, etofenprox, fenpropathrin, fenvalerate, flucythrinate, flumethrin, tau-Fluvalinate, halfenprox, imiprothrin, kadethrin, permethrin, phenothrin [(1R)-trans-isomer], prallethrin, pyrethrins (pyrethrum), resmethrin, silafluofen, tefluthrin, tetramethrin, tetramethrin [(1R)-isomers], tralomethrin and transfluthrin.

According to another embodiment of the present invention, there is provided an agricultural composition comprising:
superabsorbent polymer,
bifenthrin, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant
bifenthrin, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a diamide, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant,
a diamide, and
a solvent system comprising water and glycolic solvent in a ratio from 1:3 to 3:1,

wherein the composition is in the form of a flowable suspension.

In an embodiment, the diamide is selected from the group comprising chlorantraniliprole, cyantraniliprole, cyclaniliprole flubendiamide and tetraniliprole.

According to another embodiment of the present invention, there is provided an agricultural composition comprising:
superabsorbent polymer,
chlorantraniliprole, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant,
chlorantraniliprole, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a phenylpyrazole, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant,
a phenylpyrazole, and
a solvent system comprising water and glycolic solvent in a ratio from 1:3 to 3:1,

wherein the composition is in the form of a flowable suspension.

In an embodiment, the phenylpyrazole is selected from the group comprising ethiprole and fipronil.

According to another embodiment of the present invention, there is provided an agricultural composition comprising:
superabsorbent polymer,
fipronil, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant,
fipronil, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a neonicotinoid, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant,
a neonicotinoid, and
a solvent system comprising water and glycolic solvent in a ratio from 1:3 to 3:1,

wherein the composition is in the form of a flowable suspension.

In an embodiment, the neonicotinoid is selected from the group comprising acetamiprid, clothianidin, dinotefuran, imidacloprid, nitenpyram, thiacloprid and thiamethoxam.

According to another embodiment of the present invention, there is provided an agricultural composition comprising:
superabsorbent polymer,
imidacloprid, and
a solvent system comprising water and glycolic solvent in a ratio from 1:3 to 3:1,

wherein the composition is in the form of a flowable suspension.

According to another embodiment of the present invention, there is provided an agricultural composition comprising:
superabsorbent polymer,
a dispersant,
imidacloprid, and
a solvent system comprising water and glycolic solvent in a ratio from 1:3 to 3:1,

wherein the composition is in the form of a flowable suspension.

According to an embodiment of the present invention, there is provided a process of preparing a composite system for agriculture comprising superabsorbent polymer, and a solvent system comprising water and a glycolic solvent in a ratio from 1:3 to 3:1; wherein said process comprising steps of:
mixing at least one glycolic solvent with water to obtain solvent system,
adding superabsorbent polymer under high shear to obtain composite system for agriculture as a flowable suspension.

According to an embodiment of the present invention, there is provided a process of preparing a composite system for agriculture comprising superabsorbent polymer, and a solvent system comprising water and a glycolic solvent in a ratio from 1:3 to 3:1; wherein said process comprising steps of:
mixing at least one glycolic solvent with water to obtain a solvent system,
adding superabsorbent polymer under high shear to obtain composite system for agriculture as a flowable suspension.

According to an embodiment of the present invention, there is provided a process of preparing a composite system for agriculture comprising superabsorbent polymer, and a solvent system comprising water and glycolic solvent in a ratio from 1:3 to 3:1; wherein said process comprising steps of:
mixing at least one glycolic solvent with water to obtain solvent system,
adding dispersing agent and biocide to the solvent system of above step; and
adding superabsorbent polymer under high shear to obtain composite system for agriculture as a flowable suspension.

According to an embodiment of the present invention, there is provided a process of preparing a composite system for agriculture comprising superabsorbent polymer, and a solvent system comprising water and glycolic solvent in a ratio from 1:3 to 3:1; wherein said process comprising steps of:
mixing at least one glycolic solvent with water to obtain solvent system,
adding dispersing agent and biocide to the solvent system of above step; and
   adding starch-g-poly(2-propenamide-co-2-propanoic acid, potassium salt with 100 mesh size under high shear to obtain composite system for agriculture as a flowable suspension.

According to an embodiment of the present invention, there is provided a process of preparing a composition comprising superabsorbent polymer, and a solvent system comprising water and glycolic solvent in a ratio from 1:3 to 3:1; wherein said process comprising steps of:
mixing at least one glycolic solvent with water to obtain solvent system,
adding dispersing agent and biocide to the solvent system of above step; and
   adding starch-g-poly(2-propenamide-co-2-propanoic acid, potassium salt with 100 mesh size under high shear to obtain composite system for agriculture as a flowable suspension.

According to an embodiment of the present invention, blending of composite system or composition is carried out in suitable mixing equipment such as shaker, homogenizer or gravity mixer.

According to an embodiment of the present invention, blending of superabsorbent polymer and solvent system is carried out from about 30 sec to about 15 min to obtain homogeneous polymeric material composition.

According to an embodiment of the present invention, there is provided a method of enhancing seedling development, said method comprising: applying to seeds of agriculture crops, an effective amount of a composite system comprising superabsorbent polymer, and a solvent system comprising water and glycolic solvent in a ratio from 1:3 to 3:1 wherein said composite system is in the form of a flowable suspension.

According to an embodiment of the present invention, there is provided a method of enhancing seedling development, said method comprising: applying to seeds of agriculture crops, an effective amount of a composite system comprising starch-g-poly(2-propenamide-co-2-propanoic acid, potassium salt), and a solvent system comprising water and glycolic solvent in a ratio from 1:3 to 3:1 wherein said composite system is in the form of a flowable suspension.

According to an embodiment of the present invention, there is provided a method of enhancing seedling development, said method comprising: applying to seeds of agriculture crops, an effective amount of a composite system comprising superabsorbent polymer, at least one active ingredient and a solvent system comprising water and glycolic solvent in a ratio from 1:3 to 3:1 wherein said composite system is in the form of a flowable suspension.

According to an embodiment of the present invention, there is provided a method of enhancing seedling development, said method comprising: applying to seeds of agriculture crops, an effective amount of a composite system for agriculture comprising starch-g-poly(2-propenamide-co-2-propanoic acid, potassium salt) having 100 mesh size, at least one agrochemical ingredient and a solvent system comprising water and glycolic solvent in a ratio from 1:3 to 3:1 wherein said composite system is in the form of a flowable suspension.

According to an embodiment of the present invention, there is provided a method of enhancing seedling development, said method comprising: applying to seeds of agriculture crops, an effective amount of a composite system for agriculture comprising starch-g-poly(2-propenamide-co-2-propanoic acid, potassium salt), and a solvent system comprising water and glycolic solvent in a ratio from 1:3 to 3:1 wherein said composite system is in the form of a flowable suspension.

According to an embodiment of the present invention, there is provided a method of enhancing seedling development, said method comprising: applying to seeds of agriculture crops, an effective amount of a composite system for agriculture comprising SAP, and a solvent system comprising water and glycolic solvent in a ratio from 1:3 to 3:1 wherein said composite system is in the form of a flowable suspension, and wherein the composite system is applied to the seeds in combination with other seed treating agents selected from the group comprising of one or more herbicides, plant growth regulators, crop dessicants, fungicides, bacteriocides, bacteriostats, insecticides, insect repellants, triazine herbicides, sulfonylurea herbicides, uracils, urea herbicides, acetanilide herbicides, organophosphonate herbicides, glyphosate salts, glyphosate esters, nitrilo oxime fungicides, imidazole fungicides, triazole fungicides, sulfenamide fungicides, dithio-carbamate fungicides, chloronated aromatic, dichloro aniline fungicides, carbamate insecticides, organo thiophosphate insecticides; perchlorinated glycolic insecticides, methoxychlor, miticides, propynyl sulfite, triazapentadiene miticides, chlorinated aromatic miticides, tetradifan, dinitrophenol miticides, binapacryl, adjuvants, surfactants, fertilizers or any mixture thereof.

According to an embodiment of the present invention, there is provided a method of improving soil quality, said method comprising: applying to soil, an effective amount of a composite system for agriculture comprising superabsorbent polymer, and a solvent system comprising water and glycolic solvent in a ratio from 1:3 to 3:1 wherein said composite system is in the form of a flowable suspension.

According to an embodiment of the present invention, there is provided a method of improving soil quality, said method comprising: applying to soil, an effective amount of a composite system for agriculture comprising superabsorbent polymer, and a solvent system comprising water and glycolic solvent in a ratio from 1:3 to 3:1 wherein said composite system is in the form of a flowable suspension, and wherein the composite system is applied to the soil for water retention and micronutrient enrichment wherein one or more micronutrients depending on the type of application, such as agricultural, horticultural, turf, etc., soil conditions, climate conditions and various other factors that would be appreciated by those having skill in the art with the aid of the present disclosure. Exemplary micronutrients may be included in salt form, or otherwise, and may include an agriculturally useful multivalent cation solution having elemental components which include, but are not limited to, magnesium (Mg), iron (Fe), manganese (Mn), boron (B), calcium (Ca), copper (Cu), molybdenum (Mo), nickel (Ni), and zinc (Zn).

According to an embodiment of the present invention, there is provided a method of improving soil quality, said method comprising: applying to soil, an effective amount of a composite system for agriculture comprising superabsorbent polymer, and a solvent system comprising water and glycolic solvent in a ratio from 1:3 to 3:1 wherein said composite system is in the form of a flowable suspension and wherein water retention capacity of the composite system ranges from 200 to 800 times of the weight of the SAP.

According to an embodiment of the present invention, there is provided a method of improving soil quality, said method comprising: applying to seeds of agriculture crops, an effective amount of a composite system for agriculture wherein the composite system for agriculture may be applied during planting of a seed or during transplanting of a plant. For example, the composite system for agriculture can be metered out through an orifice of a spray nozzle in a band with the seed at planting. Additionally, the composite system for agriculture can applied post planting or post-transplanting. For instance, the composite system for agriculture may be injected into the root zone of existing vegetation, such as turf, through non-invasive liquid injection technology.

In another aspect of the present invention, there is provided a method of enhancing propagation in plants, said method comprising applying to propagation material of agriculture crops, an effective amount of the composition comprising a superabsorbent polymer, and a solvent system comprising water and a glycolic solvent in a ratio ranging from 1:3 to 3:1; wherein said composition is in the form of a flowable suspension.

In another aspect of the present invention, there is provided a method of enhancing seedling development, said method comprising: applying to seeds of agriculture crops, an effective amount of a composition comprising a superabsorbent polymer, and a solvent system comprising water and glycolic solvent in a ratio ranging from 1:3 to 3:1; wherein said composition is in the form of a flowable suspension.

In another aspect of the present invention, there is provided a method of improving soil quality comprising applying to soil, an effective amount of a composition for agriculture comprising superabsorbent polymer, and a solvent system comprising water and glycolic solvent in a ratio ranging from 1:3 to 3:1 wherein said composition is in the form of a flowable suspension.

In another aspect of the present invention, the composite system for agriculture is used as a vehicle to aid agrochemical treatment of seeds and soil.

According to an embodiment of the present invention, the composite system for agriculture is used as a vehicle to aid agrochemical treatment of seeds and soil.

According to an embodiment of the present invention, the composite system for agriculture is used as a vehicle to aid agrochemical treatment of seeds by providing a coat of SAP necessary for seed hydration.

According to an embodiment of the present invention, the composite system for agriculture is used as a vehicle to add active ingredients necessary for agrochemical treatment of seeds.

According to an embodiment of the present invention, the composite system for agriculture is used in soil for increasing water holding capacity of the land.

It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the invention.

### EXAMPLES

### Example 1: SAP 2% Flowable Suspension

| | Quantity |
|---|---|
| Ingredients | (% w/w) |
| Water | 29.7 |
| Propylene glycol | 65 |
| Hydrophilic methyl methacrylate graft copolymer | 3 |
| benzisothiazolinone | 0.3 |
| poly(2-propenamide-co-2-propanoic acid, sodium | 2 |
| salt) | |
| Total | 100 |

65 g propylene glycol and 29.7 g water constituting the solvent system were mixed to obtain mixture. To the mixture, 3 g hydrophilic methyl methacrylate graft copolymer and 0.3 g biocide were added. Further, 2 g SAP was added to the mixture under shaking to obtain the composite system as flowable suspension.

### Example 2: SAP 1.5% Flowable Suspension

| | Quantity |
|---|---|
| Ingredients | (% w/w) |
| Water | 30.2 |
| Propylene glycol | 65 |
| Hydrophilic methyl methacrylate graft copolymer | 3 |
| benzisothiazolinone | 0.3 |
| poly(2-propenamide-co-2-propanoic acid, sodium | 1.5 |
| salt) | |
| Total | 100 |

Water, propylene glycol, hydrophilic methyl methacrylate graft copolymer, biocide and SAP was mixed in above quantity and formed 1.5% flowable suspension according to the process disclosed in Example-1.

### Example 3: SAP 2% Flowable Suspension

| | Quantity |
|---|---|
| Ingredients | (% w/w) |
| Water | 19.7 |
| Mono ethylene glycol | 75 |
| Hydrophilic methyl methacrylate graft copolymer | 3 |
| benzisothiazolinone | 0.3 |
| poly(2-propenamide-co-2-propanoic acid, sodium | 2 |
| salt) | |
| Total | 100 |

Water, monoethylene glycol, hydrophilic methyl methacrylate graft copolymer, biocide and SAP were mixed in above quantity and formed 2% flowable suspension according to the process disclosed in Example-1.

### Example 4: SAP 3% Flowable Suspension

| | Quantity |
|---|---|
| Ingredients | (% w/w) |
| Water | 19.7 |
| Propylene glycol | 72 |
| EO-PO block copolymers | 5 |
| benzisothiazolinone | 0.3 |
| poly(2-propenamide-co-2-propanoic | 3 |
| acid, sodium salt) | |
| Total | 100 |

Water, propylene glycol, EO-PO block copolymers, biocide and SAP were mixed in above quantity and formed 3% flowable suspension according to the process disclosed in Example-1.

### Example 5: 2% SAP Flowable Suspension

| | Quantity |
|---|---|
| Ingredients | (% w/w) |
| Water | 29.7 |
| Mono ethylene glycol | 65 |
| Hydrophilic methyl methacrylate graft copolymer | 3 |
| benzisothiazolinone | 0.3 |
| starch-g-poly (2-propenamide-co-2-propenoic | 2 |
| acid) potassium salt | |
| Total | 100 |

Water, mono ethylene glycol, hydrophilic methyl methacrylate graft copolymer, biocide and SAP-starch-g-poly (2-propenamide-co-2-propenoic acid) potassium salt (100 mesh) were mixed in above quantity and formed 2% flowable suspension according to the process disclosed in Example-1.

### Example 6: 5% SAP Flowable Suspension

| | Quantity |
|---|---|
| Ingredients | (% w/w) |
| Water | 19.7 |
| Propylene glycol | 70 |
| Hydrophilic methyl methacrylate graft copolymer | 5 |
| benzisothiazolinone | 0.3 |
| starch-g-poly (2-propenamide-co-2-propenoic | 5 |
| acid) potassium salt | |
| Total | 100 |

Water, propylene glycol, hydrophilic methyl methacrylate graft copolymer, biocide and SAP-starch-g-poly (2-propenamide-co-2-propenoic acid) potassium salt (100 mesh) were mixed in above quantity and formed a 5% flowable suspension according to the process disclosed in Example-1.

### Example 7: 2% SAP Flowable Suspension

| | Quantity |
|---|---|
| Ingredient | (% w/w) |
| Water | 29.75 |
| Propylene Glycol | 65.00 |
| hydrophilic methyl methacrylate graft copolymer | 3.00 |
| benzisothiazolinone | 0.25 |
| starch-g-poly (2-propenamide-co-2-propenoic | 2.00 |
| acid) potassium salt | |
| Total | 100.00 |

Water, propylene glycol, hydrophilic methyl methacrylate graft copolymer, biocide and SAP-starch-g-poly (2-propenamide-co-2-propenoic acid) potassium salt (100 mesh) were mixed in above quantity and formed-SAP 2% flowable suspension according to the process disclosed in Example-1.

### Example 8: 2% SAP Flowable Suspension

| | Quantity |
|---|---|
| Ingredient | (% w/w) |
| Water | 24.95 |
| Propylene Glycol | 70.00 |
| Acrylic copolymer solution | 3.00 |
| benzisothiazolinone | 0.05 |
| starch-g-poly (2-propenamide-co-2-propenoic | 2.00 |
| acid) potassium salt | |
| Total | 100.00 |

Water, propylene glycol, acrylic copolymer solution, biocide and SAP (starch-g-poly(2-propenamide-co-2-propenoic acid) potassium salt-SAP 100 mesh) were mixed in above quantity and formed starch-g-poly(2-propenamide-co-2-propenoic acid) potassium salt-SAP 2% flowable suspension according to the process disclosed in Example-1.

### Example 9: 2% w/w SAP+0.4% w/w Fipronil Flowable Suspension

| Ingredient | Wt. % |
|---|---|
| Fipronil | 0.40 |
| Propylene Glycol | 65.00 |
| hydrophilic methyl methacrylate graft copolymer | 3.00 |
| benzisothiazolinone | 0.25 |
| starch-g-poly (2-propenamide-co-2-propenoic | 2.00 |
| acid) potassium salt | |
| Water | QS |
| Total | 100.00 |

Fipronil, propylene glycol, hydrophilic methyl methacrylate graft copolymer, biocide, SAP (starch-g-poly(2-propenamide-co-2-propenoic acid) potassium salt-SAP 100 mesh) and water were mixed in above quantity and formed starch-g-poly(2-propenamide-co-2-propenoic acid) potassium salt-SAP 2% flowable suspension according to the process disclosed in Example-1.

### Example 10: 2% w/w SAP+0.4% w/w Chlorantraniliprole Flowable Suspension

| Ingredient | Wt. % |
|---|---|
| Chlorantraniliprole | 0.40 |
| Propylene Glycol | 65.00 |
| hydrophilic methyl methacrylate graft copolymer | 3.00 |
| benzisothiazolinone | 0.25 |
| starch-g-poly (2-propenamide-co-2-propenoic | 2.00 |
| acid) potassium salt | |
| Water | QS |
| Total | 100.00 |

Chlorantraniliprole, propylene glycol, hydrophilic methyl methacrylate graft copolymer, biocide, SAP: starch-g-poly (2-propenamide-co-2-propenoic acid) potassium salt (Zeba 100 mesh) and water were mixed in above quantity and formed starch-g-poly(2-propenamide-co-2-propenoic acid) potassium salt-SAP 2% flowable suspension according to the process disclosed in Example-1.

### Example 11: 2% w/w SAP+0.4% w/w Bifenthrin Flowable Suspension

| Ingredient | Wt. % |
|---|---|
| Bifenthrin | 0.40 |
| Propylene Glycol | 65.00 |
| hydrophilic methyl methacrylate graft copolymer | 3.00 |
| benzisothiazolinone | 0.25 |
| starch-g-poly (2-propenamide-co-2-propenoic | 2.00 |
| acid) potassium salt | |
| Water | QS |
| Total | 100.00 |

Bifenthrin, propylene glycol, hydrophilic methyl methacrylate graft copolymer, biocide, SAP: starch-g-poly (2-propenamide-co-2-propenoic acid) potassium salt (Zeba 100 mesh) and water were mixed in above quantity and formed starch-g-poly(2-propenamide-co-2-propenoic acid) potassium salt-SAP 2% flowable suspension according to the process disclosed in Example-1.

### Example 12: Physico-Chemical Properties of Composite System

Composition of Example-8 developed according to the process described in the present invention was evaluated for physico-chemical parameters. The composite system thus obtained appears to be colourless viscous liquid with viscosity ranging between 1500-2410 cps. pH of the composite system found to be 6-8 which signified neutral behaviour of the composite system suitable for further mixing with wide variety of other active ingredients, micronutrients and adjuvants. (Table 1)

TABLE 1

| Parameter | Typical results |
|---|---|
| Appearance | Colourless viscous liquid |
| Viscosity (Cps.) Spindle #63, 60 | 1500 to 2410 |
| rpm | |
| pH (as such) | 6.0 to 8.0 |

### Example 13 Composite System Compatibility Test

The composite system for agriculture developed as per the present invention was evaluated for its compatibility with other compositions used often in agricultural practices either in customed blending or during tank mixing.

The custom blend was prepared by mixing Imidacloprid 600FS (Tradename: StartUP IMIDA), Fludioxonil 317 FS (Tradename: StartUP FLUDI), Flurazole 240 FS and Metalxyl 317 FS (Tradename: StartUP METXL), pigment and water in below mentioned quantities (Table-2). Similarly, in another study composite system of Example-8 was mixed in the custom blend. Both the preparations were than evaluated on various stability parameters. (Table 3). It was found that the custom blend as well as custom blend mixed with composite system found to be nearly equal on almost all stability parameters studied such as appearance, density, pH, viscosity, particle size, wet screen retention, bleeding and sedimentation. This signifies that the composite system behaved neutral and does not alter any of the essential parameters of the custom blend thus found to be suitable for custom blend as well as tank mixing.

TABLE 2

| | Rate | Custom Blend + | Rate |
|---|---|---|---|
| Custom Blend | ml/100 kg | Example-8 | ml/100 kg |
| Water | 313.34 | Composite system of | 130.56 |
| Imidacloprid 600 FS | 417.79 | Example-8 | |
| Metalaxyl 317 FS | 26.11 | Water | 182.78 |
| Fludioxonil 480 FS | 5.22 | Imidacloprid 600 FS | 417.79 |
| Flurazole 240 FS | 208.90 | Metalaxyl 317 FS | 26.11 |
| Red Pigment | 19.58 | Fludioxonil 480 FS | 5.22 |
| dispersion | | Flurazole 240 FS | 208.90 |
| Water | 53.53 | Red Pigment dispersion | 19.58 |
| Total | 1044.5 | Water | 53.53 |
| | | Total | 1044.5 |

TABLE 3
Custom blend stability evaluation

| | | 2 Week | 1 Month | | | 2 Months | | | 3 Months | | |
|---|---|---|---|---|---|---|---|---|---|---|---|
| | Initial | Amb | Amb | 40° C. | 0° C. | Amb | 40° C. | 0° C. | Amb | 40° C. | 0° C. |
| Appearance | RD | C | C | C | C | C | C | C | C | C | C |
| Density at 20 | 1.335 | 1.336 | 1.336 | 1.336 | 1.336 | 1.336 | 1.336 | 1.336 | 1.336 | 1.336 | 1.336 |
| Deg. (g/ml) | | | | | | | | | | | |
| pH (neat) | 6.8 | 6.8 | 6.5 | 6.3 | 6.6 | 6.4 | 6.1 | 6.5 | 6.4 | 6.0 | 6.5 |
| Viscosity | 362 | 356 | 365 | 350 | 357 | 368 | 344 | 360 | 362 | 336 | 365 |
| Particle size | 2.66 | 2.57 | 2.43 | 2.62 | 2.51 | 2.44 | 2.66 | 2.46 | 2.52 | 2.77 | 2.46 |
| D50 | | | | | | | | | | | |
| Particle size | 27.7 | 25.6 | 24.7 | 28.3 | 27.8 | 24.9 | 30.2 | 28.0 | 25.6 | 29.8 | 24.9 |
| D90 | | | | | | | | | | | |
| Wet screen | Nil | Nil | Nil | Nil | Nil | Nil | Nil | Nil | Nil | Nil | Nil |
| test (120 | | | | | | | | | | | |
| Mesh) | | | | | | | | | | | |
| Bleeding | RD | <2% | 2% | 4% | <2% | 4% | 8% | 2% | 4% | 10% | 2% |
| Sedimentation | RD | NS | NS | NS | NS | NS | NS | NS | NS | NS | NS |

RD: Red colour dispersion;
C: complies means custom blend retained its identity as red colour dispersion during all testing conditions;
NS: No sediment

TABLE 4
Custom Blend + Composite system stability evaluation

| | | 2 Week | 1 Month | | | 2 Months | | | 3 Months | | |
|---|---|---|---|---|---|---|---|---|---|---|---|
| | Initial | Amb | Amb | 40° C. | 0° C. | Amb | 40° C. | 0° C. | Amb | 40° C. | 0° C. |
| Appearance | RD | C | C | C | C | C | C | C | C | C | C |
| Density at 20 | 1.339 | 1.338 | 1.338 | 1.338 | 1.338 | 1.338 | 1.338 | 1.338 | 1.338 | 1.338 | 1.338 |
| Deg. (g/ml) | | | | | | | | | | | |
| pH (neat) | 6.6 | 6.6 | 6.4 | 6.2 | 6.4 | 6.3 | 6.0 | 6.3 | 6.2 | 5.8 | 6.3 |
| Viscosity at | 387 | 390 | 395 | 388 | 380 | 389 | 386 | 408 | 415 | 427 | 405 |
| spl #62, 60 | | | | | | | | | | | |
| rpm (cps) | | | | | | | | | | | |
| Particle size | 2.34 | 2.21 | 2.45 | 2.42 | 2.36 | 2.62 | 2.48 | 2.62 | 2.56 | 2.67 | 2.7 |
| D50 | | | | | | | | | | | |
| Particle size | 22.8 | 23.7 | 24.5 | 24.8 | 25.6 | 27.9 | 27.3 | 27.0 | 27.6 | 29.7 | 27.8 |
| D90 | | | | | | | | | | | |
| Wet screen | Nil | Nil | Nil | Nil | Nil | Nil | Nil | Nil | Nil | Nil | Nil |
| test (120 | | | | | | | | | | | |
| Mesh) | | | | | | | | | | | |
| Bleeding | RD | 0% | 0% | 2% | 0% | 2% | 4% | 0% | 4% | 8% | 2% |
| Sedimentation | RD | NS | NS | NS | NS | NS | NS | NS | NS | NS | NS |

RD: Red colour dispersion;
C: complies means custom blend retained its identity as red cobur dispersion during all testing conditions.
SD: Smooth dispersion;
NS: No sediment

### Dust-Off Test

Composition of Example-7 developed according to the process described in the present invention was evaluated to study dust-off pattern of seeds treated with the composite system for agriculture. various seeds such as corn seeds, wheat seeds and soybean seeds were taken and comparative study was performed wherein three different kinds of treatments were given to each seed: 1. Treating seeds with custom blend and then coating with SAP: starch-g-poly (2-propenamide-co-2-propenoic acid) potassium salt (100 mesh) (Zeba 100 mesh) (A); 2. Treating seeds with composite system for agriculture (Example-7) developed according to the present invention (B); and 3. Seed treatment with custom blend without adding SAP (Zeba 100 mesh) (C). It was observed that the composite system for agriculture gave least dust-off in all three seeds viz. corn, wheat and soybean. Maximum dust-off was observed in seeds wherein SAP (Zeba 100 mesh) was coating onto custom blend treated seeds than treated seeds without SAP (Zeba 100 mesh). (Table 5)

TABLE 5

| | Treatment | Dust-off mg/100 gm |
|---|---|---|
| Crop | detail | seeds |
| Corn treated | A | 36 mg |
| seeds | B | 14 gm |
| | C | 20 mg |
| Wheat treated | A | 12 mg |
| seeds | B | 7 mg |
| | C | 9 mg |
| Soybean treated | A | 42 mg |
| seeds | B | 17 mg |
| | C | 28 mg |

### Effect of Composite System on Germination

Seed germination test was performed on sorghum seeds. 100 gm sorghum seeds were treated with the composite system developed as per Example-5 at various doses viz. 20 ml and 30 ml. Untreated sorghum seeds were also considered as standard. The sorghum seeds were planted in coco pits and kept for study. After treating with the composition of Example-5, no further water was given to seeds for next two days. Observations were made after 2 days. It was found that seeds treated with the composition of Example-5 at 20 ml and 30 ml dose rates showed enhanced rate of germination as compared to the untreated control (UTC). This demonstrated the effectiveness of the composite system in terms of water holding capacity and helping seeds to tolerate the stress. (Table 6 and FIG. 1)

TABLE 6

| Treatment | Dose/Kg in ml | % Germination |
|---|---|---|
| UTC | UTC | 14.5 |
| Example-5 @ 20 ml | 20 | 19.25 |
| Example-5 @ 30 ml | 30 | 42.25 |

It is clear from the experimental data, as described above, the composite system for agriculture as per present invention found to provide excellent flowable suspension suitable for seed treatment as well as soil application. The solvent system comprising water and glycolic solvent, especially glycols found to be effective in dispersing preparing wet concentrate of starch-based SAP as flowable suspension yet keeping starch-based SAP in its non-swollen state which retains its water absorbing capacity once applied to soil or onto seeds. The composite system for agriculture of the present invention found to be very useful in agriculture and horticulture applications for fluid or water retention as well as seed treatment by aiding active ingredients to adhere to seeds. The composition remained quite stable during transport and shelf life. The process described is simple, convenient to perform and does not require any heavy instruments. As such, the spirit and scope of the disclosure should not be limited to the description of the preferred embodiment contained therein.

1. A composition comprising:
(a) a superabsorbent polymer, and
(b) a solvent system comprising water and a glycolic solvent in ratio ranging 1:5 to 5:1;
wherein the composition is in the form of a flowable suspension.

2. The composition as claimed in claim 1, wherein the superabsorbent polymer is selected from the group comprising of copolymer of acrylamide and sodium acrylate, copolymer of acrylamide and potassium acrylate; hydrolyzed starch-polyacrylonitrile; 2-propenenitrile homopolymer, poly(2-propenamide-co-2-propanoic acid, sodium salt; starch-g-poly(2-propenamide-co-2-propanoic acid, mixed sodium and aluminium salts); starch-g-poly(2-propenamide-co-2-propanoic acid, potassium salt); poly(2-propenamide-co-2-propanoic acid, sodium salt); starch-g-poly (propenoic acid) sodium salt, starch-g-poly (propenoic acid) potassium salt, poly-2-propanoic acid, sodium salt; starch-g-poly(acrylonitrile) or poly(2-propenamide-co-sodium acrylate); starch/acrylonitrile copolymer; crosslinked copolymers of acrylamide and sodium acrylate; crosslinked polymers of acrylamide and sodium polyacrylate; anionic polyacrylamide; starch grafted sodium polyacrylates; crosslinked copolymers of potassium polyacrylate and polyacrylamide; sodium polyacrylate; superabsorbent polymer laminates and composites; partial sodium salt of crosslinked polypropenoic acid; potassium polyacrylate, lightly crosslinked; sodium polyacrylate, lightly crosslinked; poly(sodium acrylate) homopolymer; polyacrylamide polymers, carrageenan, agar, alginic acid, guar gums and its derivatives, and gellan gum.

3. The composition as claimed in claim 1, wherein the superabsorbent polymer is selected from the group comprising of starch-g-poly (2-propenamide-co-2-propenoic acid) potassium salt, starch-g-poly (2-propenamide-co-2-propenoic acid) sodium salt, starch-g-poly (propenoic acid) sodium salt, starch-g-poly (propenoic acid) potassium salt, sodium polyacrylamide and potassium polyacrylamide.

4. The composition as claimed in claim 1, wherein the superabsorbent polymer has a particle size ranging from about 80 mesh to about 300 mesh.

5. The composition as claimed in claim 1, wherein the superabsorbent polymer is having moisture content ranging from 5% w/w to 15% w/w of the total weight of the superabsorbent polymer,
wherein the superabsorbent polymer is having a water absorption capacity from about 300 times to about 1000 times its weight, and wherein the superabsorbent polymer is in the form of powder or granules.

6. The composition as claimed in claim 1, wherein the glycolic solvent is selected from the group comprising of diethylene glycol, propylene glycol, ethylene glycol monobutyl ether (EGBE), ethylene glycol monomethyl ether (EGME), and monoethylene glycol.

7. The composition as claimed in claim 1, wherein the composition is in the form of a flowable suspension having viscosity ranging from 500 to 2500 cps.

8. The composition as claimed in claim 1, wherein the composition comprises from about 0.01% w/w to about 30% w/w superabsorbent polymer and from about 10% w/w to about 99.9% w/w solvent system, of the total weight of the composition.

9. The composition as claimed in claim 1, wherein the solvent system comprises from about 1% w/w to about 50% w/w water and from about 10% w/w to about 80% w/w glycol, of the total weight of the composition.

10. A composition for agriculture comprising:
a superabsorbent polymer;
at least one dispersant; and
a solvent system comprising water and a glycolic solvent in a ratio ranging from 1:3 to 3:1,
wherein the composition is in the form of a flowable suspension.

11. The composition as claimed in claim 10, wherein the dispersant is selected from the group comprising of non-ionic and anionic surfactants,
wherein the non-ionic surfactant is selected from the group comprising of fatty alcohol ethoxylates, tristyrylphenol ethoxylates, alkylphenolethoxylates, castor oil ethoxylates, fatty acid ethoxylates, alkylpolyglucosides, sorbitan ethoxylates, and ethylene oxide-propylene oxide-ethylene oxide block copolymer,
wherein the anionic surfactant is selected from the group comprising salts of dodecylbenzenesulfonate, sodium dioctylsulfosuccinate, salts of tristyrylphenol ethoxylate phosphates, salts of fatty acids, salts of alkyl sulfates, salts of alkylether sulfates, salts of alkylether phosphates, and sodium N-methyl-N-oleyltaurate.

12. The composition as claimed in claim 1, wherein the composition comprises an agrochemically acceptable excipient.

13. The composition as claimed in claim 1, further comprising an agrochemically active ingredient selected from one or more of an insecticide, herbicide, fungicide, plant growth regulator and fertilizer.

14. A process of preparing a composition comprising a superabsorbent polymer, and a solvent system comprising water and a glycolic solvent of claim 1 comprising: mixing at least one glycolic solvent with water to obtain a solvent system, and adding a superabsorbent polymer under high shear to obtain the composition as a flowable suspension,
wherein mixing of the superabsorbent polymer and the solvent system is carried out from about 30 seconds to about 15 minutes to obtain a composition.

15. A method of enhancing seedling development comprising applying to seeds of agriculture crops, an effective amount of the composition of claim 1.

16. The composition as claimed in claim 10, wherein the composition comprises an agrochemically acceptable excipient.

17. The composition as claimed in claim 10, further comprising an agrochemically active ingredient selected from one or more of an insecticide, herbicide, fungicide, plant growth regulator and fertilizer.

18. A method of enhancing seedling development comprising applying to seeds of agriculture crops, an effective amount of the composition of claim 10.
